(19) United States
(12) Patent Application Publication
(10) Pub. No.: US 2026/0274663 A1
(43) Pub. Date: Sep. 17, 2026

(54) SYSTEMS, METHODS AND TECHNIQUES FOR HYDROGEN PRODUCTION FROM CHEMICAL LOOPING SYSTEMS WITH PARTICLE HEATING

(71) Applicant: Ohio State Innovation Foundation, Columbus, OH (US)

(72) Inventors: Liang-Shih Fan, Columbus, OH (US); Qiaochu Zhang, Columbus, OH (US)

(21) Appl. No.: 19/480,067

(22) PCT Filed: Jun. 11, 2024
(86) PCT No.: PCT/US2024/033369

§ 371 Date: Oct. 30, 2025

Related U.S. Application Data
(60) Provisional application No. 63/507,658, filed on Jun. 12, 2023.

(51) Int. Cl. C01B 3/382; C01B 3/40

(52) U.S. Cl. CPC C01B 3/382; C01B 3/40; C01B 2203/0233; C01B 2203/0261; C01B 2203/1047; C01B 2203/1082; C01B 2203/1241

(57) ABSTRACT

A reactor system may include at least one first type reactor, at least one second type reactor, a heat source unit, a heat exchange unit, and one or more separation units. The at least one first type reactor reacts a fuel, which may comprise biogas, with metal oxide particles. The at least one second type reactor receives reduced metal oxide particles from the at least one first type reactor and reacts those particles with steam, generating hydrogen (H₂) and oxidized metal oxide particles. The oxidized metal oxide particles are heated up in a heat exchange unit that is heated by the heat source. The heat source may generate heat by combusting air and oxidation products from the at least one first type reactor. The heated oxidized metal oxide particles may be provided to the separation unit(s) and then to the at least one first type reactor.

### CROSS-REFERENCE TO RELATED APPLICATION(S)

This application claims priority to U.S. Provisional Patent Application No. 63/507,658 filed on Jun. 12, 2023, the entire contents of which are incorporated herein by reference.

### TECHNICAL FIELD

The present disclosure relates to systems, methods and techniques for hydrogen production using chemical looping systems. Exemplary systems, methods and techniques may include particle heating and moving beds.

### INTRODUCTION

The prosperity of population growth and economic expansion throughout the world has engendered an increasing need for clean energy. However, the predominant use of fossil fuels for energy generation has led to the substantial emission of greenhouse gases, which are implicated in climate change. Considering the rising concerns about this environmental degradation, the need for clean energy sources has gained significant attention. Hydrogen, with a high heating value and only water as the combustion product, has emerged as an attractive option for reducing greenhouse gas emissions. Moreover, hydrogen can be utilized as a raw material for multiple industries like ammonia, methanol, steel, and oil refineries. Besides, hydrogen is also acknowledged as a potential fuel for vehicles in the future. Efficient and economical hydrogen production has become a topic of worldwide interest.

Hydrogen can be produced through various methods, among which steam methane reforming (SMR) is the most widely used method due to its cost-effectiveness and high efficiency. In the SMR process, high-temperature steam reacts with methane in the presence of the catalyst, producing hydrogen, carbon monoxide, and small amounts of carbon dioxide. The carbon monoxide is subsequently converted to carbon dioxide through a water-gas shift reaction to increase the hydrogen yield. SMR produces hydrogen mixed with other compounds, necessitating a separation process to produce high-purity hydrogen. Pressure swing adsorption (PSA) is a commonly used technique that can yield hydrogen with a purity of up to 99.9%. Another promising alternative for the production of hydrogen is auto-thermal reforming (ATR). Unlike conventional steam reforming, ATR does not require external heating for steam reforming. Instead, the heat required for the reaction is balanced by coupling the partial oxidation of methane with the steam reforming reaction.

Biogas is a renewable fuel that can be produced from various organic sources, including municipal waste, food waste, farm waste, and crops. Typical biogas contains methane (50-75%), carbon dioxide (25-50%), and smaller amounts of nitrogen (2-8%). Biogas can serve as a viable source for hydrogen production, given its carbon-neutral nature that obviates the need for carbon dioxide sequestration. Utilizing biogas as the primary source for hydrogen generation offers several benefits, including greenhouse gas emissions reduction, trash recycling, and environmental sustainability.

Conventionally, the production of hydrogen from low-quality fuels, such as biogas (mainly containing CH₄ and CO₂), can be fulfilled by steam reforming (SR) and mix reforming (MR) processes. In the SR process, biogas is first upgraded to remove impurities like sulfur and carbon dioxide. The purified biomethane is then mixed with steam and injected into the steam reformer to produce syngas, resulting in a mixture of hydrogen and carbon monoxide. The carbon monoxide is then converted into hydrogen through the water-gas shift reaction. Finally, the raw hydrogen product is purified through PSA. In the MR process, after sulfur removal but without CO₂ removal, the low-quality fuels directly mix with steam and enter the reformer to produce syngas mainly containing CO, H₂, CO₂, and H₂O. Subsequent operations are the same as in the SR process.

Chemical looping is a versatile technology platform that can be utilized for hydrogen production. Chemical looping employs a solid oxygen carrier, typically a metal oxide, which facilitates the conversion of fuels like natural gas, biogas (mainly containing CH₄ and CO₂), syngas (mainly containing CO, H₂, CO₂), etc., into hydrogen. The conventional chemical looping three-reactor (CL-3R) system for hydrogen production consists of a counter-current moving bed reducer, a counter-current oxidizer, and a fluidized-bed combustor reactor. The fuel injected into the reducer is oxidized by the oxygen carrier particles that are reduced to a lower oxidation state simultaneously. Then the reduced oxygen carrier particles enter the oxidizer reactor, where the reduced oxygen carrier reacts with steam to produce hydrogen. Finally, the oxygen carrier particles fluidize with air in the combustor and are oxidized by the air to the initial oxidation state, closing the loop. Experimental studies carried out with iron-based oxygen carriers in conjunction with diverse transition metal oxides have demonstrated promising results concerning redox activity and stability.

### SUMMARY

In some aspects, the techniques described herein relate to a method of operating a reactor system, the method including: providing metal oxide particles to a first type reactor, the metal oxide particles including metal oxide selected from ZnO, SnO₂, Fe₃O₄, NiO, MnO₂, CoO, and Cr₂O₃ and an inert material; providing gaseous fuel to the first type reactor, thereby reacting the metal oxide particles with the gaseous fuel to generate oxidation products and reduced metal oxide particles; operating the first type reactor at a temperature between 800° C. and 1100° C.; providing oxidation products from the first type reactor to a heat source unit; providing reduced metal oxide particles from the first type reactor to a second type reactor; providing steam to the second type reactor, thereby reacting the reduced metal oxide particles with the steam to generate hydrogen (H₂) and oxidized metal oxide particles; collecting hydrogen (H₂) from the second type reactor; operating the second type reactor at a temperature between 800° C. and 1100° C.; providing oxidized metal oxide particles to a heat exchange unit; providing heat from the heat source unit to the heat exchange unit; increasing the temperature of the oxidized metal oxide particles in the heat exchange unit; providing oxidized metal oxide particles from the heat exchange unit to a separation unit; separating oxidized metal oxide particles from carrier gas in the separation unit; and providing oxidized metal oxide particles from the separation unit to the first type reactor.

In some aspects, the techniques described herein relate to a reactor system, including: at least one first type reactor in fluid communication with a fuel source and a separation unit, the at least one first type reactor configured to: receive metal oxide particles from the separation unit; generate oxidation products by reacting the metal oxide particles with fuel from the fuel source; and provide the oxidation products from an outlet; at least one second type reactor in fluid communication with the at least one first type reactor, the at least one second type reactor configured to receive steam from a steam source; receive reduced metal oxide particles from the at least one first type reactor; generate hydrogen (H₂) by reacting the steam and the reduced metal oxide particles; and provide hydrogen (H₂) from an outlet of the at least one second type reactor; a heat source unit in fluid communication with an outlet of the at least one first type reactor and configured to receive oxidation products from the at least one first type reactor; a heat exchange unit in fluid communication with the at least one second type reactor and configured to: receive heat from the heat source unit; receive oxidized metal oxide particles from the at least one second type reactor; provide oxidized metal oxide particles at an increased temperature to the separation unit, the increased temperature being relative to a temperature exiting the at least one second type reactor; and the separation unit being in fluid communication with the heat exchange unit and the at least one first type reactor, the separation unit configured to separate a carrier gas from the oxidized metal oxide particles and provide the oxidized metal oxide particles to the at least one first type reactor.

### BRIEF DESCRIPTION OF THE DRAWINGS

FIG. 1 shows an embodiment of a two-reactor chemical looping reactor system combined with a furnace process.

FIG. 2 shows an alternative embodiment of a two-reactor chemical looping reactor system combined with a furnace process.

FIG. 3 shows an embodiment of heat integration between the furnace and particles from the reducer outlet.

FIG. 4 shows an alternative embodiment of heat integration between the furnace and particles from the reducer outlet.

FIG. 5 shows the flow diagram of the CL-2R system used for experimental data generation.

### DETAILED DESCRIPTION

Systems, methods, and techniques disclosed and contemplated herein relate to hydrogen generation using chemical looping systems. Exemplary systems may utilize only a first reactor type and a second reactor type. In various instances, the first reactor type may comprise more than one reactor. In various instances, the second reactor type may comprise more than one reactor. Typically, exemplary reactors are moving bed reactors.

### I. Definitions

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifiers “about” or “approximately” used in connection with a quantity are inclusive of the stated value and has the meaning dictated by the context (for example, it includes at least the degree of error associated with the measurement of the quantity). These modifiers should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

Definitions of specific functional groups and chemical terms are described in more detail below. For purposes of this disclosure, the chemical elements are identified in accordance with the Periodic Table of the Elements, CAS version, Handbook of Chemistry and Physics, 104^{th} Ed., inside cover, and specific functional groups are defined as described therein.

### II. Exemplary Systems

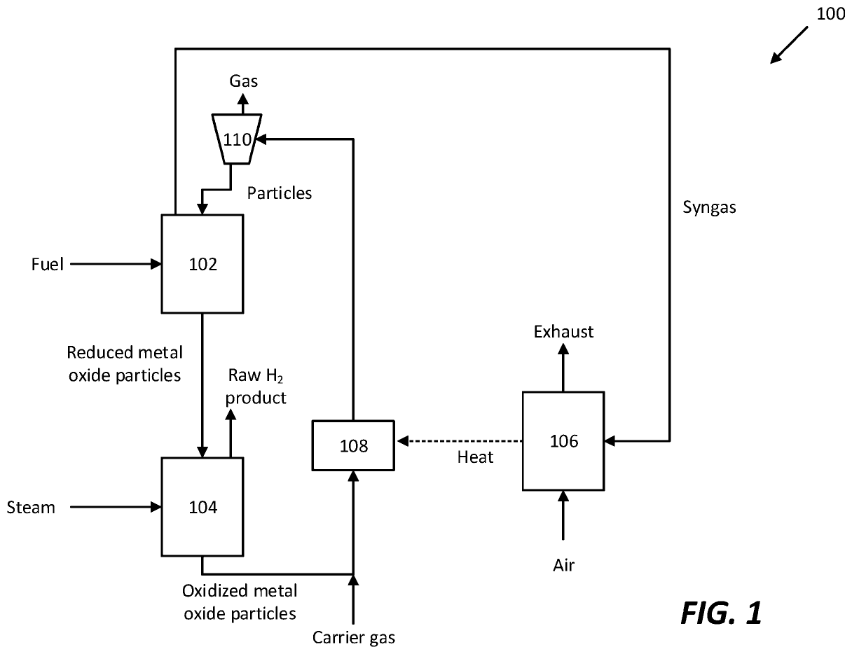

FIG. 1 schematically depicts example system 100 for generating hydrogen (H₂). As shown, system 100 comprises a first type reactor 102, a second type reactor 104, heat source 106, heat exchange unit 108, and separator 110. As shown, first type reactor 102 is in fluid communication with second type reactor 104, heat source 106, and separator 110, and second type reactor 104 is in fluid communication with first type reactor 102 and heat exchange unit 108. Other embodiments may comprise more or fewer components.

Both first type reactor 102 and second type reactor 104 are moving bed reactors. Both first type reactor 102 and second type reactor 104 are configured to be operated as counter-current moving beds.

Metal oxide particles are circulated between the reactors. In some implementations, exemplary metal oxide particles comprise both active metal oxide and inert material. In some implementations, particles including only inert material may be used in addition to particles comprising active metal oxide, where the inert material particles enhance the overall heat capacity.

Exemplary active metal oxides may include ZnO, SnO₂, Fe₃O₄, NiO, MnO₂, CoO, and Cr₂O₃. In various implementations, the one or more inert materials may comprise SiO₂, SiC, Al₂O₃, MgO, CaO, TiO₂, MgAl₂O₄, ZrO₂, yttria-stabilized ZrO₂, alumina-silicates, clay supports such as kaolin and bentonite, alumina-zirconia-silica, and combinations thereof.

When exemplary metal oxide particles comprise both metal oxide and inert material, various relative amounts of metal oxide and inert material may be used. For example, in various implementations, the one or more active metal oxides may comprise 5 weight percent (wt %) to 95 wt % of the total weight of the exemplary metal oxide particles. In various implementations, the one or more active metal oxides may comprise 10 wt % to 95 wt %; 15 wt % to 95 wt %; 20 wt % to 95 wt %; 25 wt % to 95 wt %; 30 wt % to 95 wt %; 35 wt % to 95 wt %; 40 wt % to 95 wt %; 45 wt % to 95 wt %; 50 wt % to 95 wt %; 55 wt % to 95 wt %; 60 wt % to 95 wt %; 65 wt % to 95 wt %; 70 wt % to 95 wt %; 75 wt % to 95 wt %; 80 wt % to 95 wt %; 85 wt % to 95 wt %; 90 wt % to 95 wt %; 5 wt % to 90 wt %; 5 wt %; to 85 wt %; 10 wt % to 85 wt %; 15 wt % to 85 wt %; 20 wt % to 85 wt %; 20 wt % to 80 wt %; 25 wt % to 80 wt %; 25 wt % to 75 wt %; 30 wt % to 75 wt %; 30 wt % to 70 wt %; 35 wt % to 70 wt %; 35 wt % to 65 wt %; 40 wt % to 65 wt %; 40 wt % to 60 wt %; 45 wt % to 60 wt %; 45 wt % to 55 wt %; or about 50 wt %. In various implementations, the one or more active metal oxides may comprise no less than 5 wt %; no less than 15 wt %; no less than 25 wt %; no less than 35 wt %; no less than 45 wt %; no less than 55 wt %; no less than 65 wt %; no less than 75 wt %; or no less than 85 wt % of the total weight of the exemplary metal oxide particles. In various implementations, the one or more active metal oxides may comprise no greater than 95 wt %; no greater than 90 wt %; no greater than 80 wt %; no greater than 70 wt %; no greater than 60 wt %; no greater than 50 wt %; no greater than 40 wt %; no greater than 30 wt %; no greater than 20 wt %; or no greater than 10 wt % of the total weight of the exemplary metal oxide particles.

In various implementations, the inert material may comprise 5 wt % to 95 wt % of the total weight of the exemplary oxygen carriers. In various implementations, the inert material may comprise 10 wt % to 95 wt %; 15 wt % to 95 wt %; 20 wt % to 95 wt %; 25 wt % to 95 wt %; 30 wt % to 95 wt %; 35 wt % to 95 wt %; 40 wt % to 95 wt %; 45 wt % to 95 wt %; 50 wt % to 95 wt %; 55 wt % to 95 wt %; 60 wt % to 95 wt %; 65 wt % to 95 wt %; 70 wt % to 95 wt %; 75 wt % to 95 wt %; 80 wt % to 95 wt %; 85 wt % to 95 wt %; 90 wt % to 95 wt %; 5 wt % to 90 wt %; 5 wt %; to 85 wt %; 10 wt % to 85 wt %; 15 wt % to 85 wt %; 20 wt % to 85 wt %; 20 wt % to 80 wt %; 25 wt % to 80 wt %; 25 wt % to 75 wt %; 30 wt % to 75 wt %; 30 wt % to 70 wt %; 35 wt % to 70 wt %; 35 wt % to 65 wt %; 40 wt % to 65 wt %; 40 wt % to 60 wt %; 45 wt % to 60 wt %; 45 wt % to 55 wt %; or about 50 wt % of the total weight of the exemplary metal oxide particles. In various implementations, the inert material may comprise no less than 5 wt %; no less than 15 wt %; no less than 25 wt %; no less than 35 wt %; no less than 45 wt %; no less than 55 wt %; no less than 65 wt %; no less than 75 wt %; or no less than 85 wt % of the total weight of the exemplary metal oxide particles. In various implementations, the inert material may comprise no greater than 95 wt %; no greater than 90 wt %; no greater than 80 wt %; no greater than 70 wt %; no greater than 60 wt %; no greater than 50 wt %; no greater than 40 wt %; no greater than 30 wt %; no greater than 20 wt %; or no greater than 10 wt % of the total weight of the exemplary metal oxide particles.

In certain embodiments, the metal oxide particles may comprise an iron-based composite metal oxide where the extent of reduction of the particles is from primarily Fe₃O₄ to Fe/Fe_{0.947}O/FeO in the first type reactor 102 and from Fe/Fe_{0.947}O/FeO to Fe₃O₄ in the second type reactor 104. In various implementations, the D₉₀ particle size may range from 0.4 mm to 10 mm in diameter.

Exemplary system 100 only includes the first type reactor 102 and the second type reactor 104. First type reactor 102 may comprise more than one reactors of the same type. Second type reactor 104 may comprise more than one reactors of the same type. In some implementations, the exemplary system 100 does not include a third type reactor that is a combustor reactor that receives solid particles from the first type and second type reactors in a looping system.

First type reactor 102 is configured as a reducer reactor. In the first type reactor 102, the metal oxide particles flow downwards in a packed moving bed manner. When the fuel is gaseous, the gas flows upwards in the reactor, where the velocity of the gas is maintained below the minimum fluidizing velocity of the solid particles.

The reducing feedstock (fuel) is injected to the bottom of the reactor to react with the metal oxide particles to generate one or more oxidation products, while the metal oxide particles undergo reduction and transfer to a lower oxidation state. In various implementations, exemplary oxidation products may comprise CO₂, H₂O, CO, H₂, and/or other species. As shown in example system 100, the fuel is gaseous. Oxidation products generated in first type reactor 102 may be provided to heat source 106.

The feedstock fuel can be in the form of gas, liquid, solid, or a combination thereof. Exemplary feedstocks typically comprise carbon and hydrogen (also referred to as being “carbonaceous feedstocks”). In various implementations, solid fuels may include coal, biomass, petcoke, plastics, metallurgical coke, municipal solid waste, animal wastes, etc. In various implementations, liquid fuels may include high-chain petroleum products, waste streams from pulp processing industries, food wastes, sewage sludge, diesel, etc.

When fuel comprises solids, the solid fuel may be gasified in the first type reactor 102. Then the gasified products may react with the metal oxide particles and reduce the metal oxide particles to a lower oxidation state.

In some implementations, the fuel may be biogas. Because of the carbon-neutral nature of the biogas and biomass, the CO₂ in the heat source 106 can be released into the atmosphere without the need to capture it. However, additional CO₂ capture units, not shown, such as an amine scrubber, may be required if fossil fuel is used as feedstock.

When biogas is used as fuel, system 100 may additionally comprise one or more sulfur removal units. The one or more sulfur removal units remove hydrogen sulfide (H₂S) from the biogas to prevent formation of iron sulfide in the first type reactor 102.

Various biogas sources may comprise 50-80 volume percent (vol %) methane (CH₄), 25-50 vol % carbon dioxide (CO₂) and 0-10 vol % nitrogen (N₂). In some instances, biogas may comprise 50-60 volume percent (vol %) methane (CH₄), 35-45 vol % carbon dioxide (CO₂) and 1-10 vol % nitrogen (N₂). In some instances, a molar ratio of methane (CH₄) to nitrogen (N₂) may be between 11:1 and 9:1; between 10.5:1 and 9.5:1; or 10:1.

Second type reactor 104 is configured as an oxidizer reactor. In the implementation shown, first type reactor 102 is positioned vertically above second type reactor 104. The second type reactor 104 receives metal oxide particles from the first type reactor 102 at one or more inlets. The second type reactor 104 also receives steam from a steam source at one or more inlets.

In the second type reactor 104, the reduced metal oxide particles from the first type reactor 102 flow downwards from the top of the second type reactor 104 in a packed moving bed manner. In the second type reactor 104, the gas flows upwards where the fuel velocity is maintained below the minimum fluidizing velocity of the metal oxide particles.

Steam is injected to the bottom of the second type reactor 104 to react with reduced metal oxide particles from the outlet of the first type reactor 102. Reactions within the second type reactor 104 generate hydrogen (H₂), and the raw hydrogen (H₂) is discharged from an outlet of the second type reactor. The oxidation state of the oxygen carrier at the outlet of the second type reactor 104 returns to the same initial oxidation state as at the first type reactor 102 particle inlet.

Second type reactor 102 provides oxidized metal oxide particles to heat exchange unit 108. Carrier gas may be provided to an outlet stream from second type reactor 102 to carry the metal oxide particles to heat exchange unit 108.

Heat source 106 provides heat to heat exchange unit 108, but does not provide any material transport to other system components. In heat source 106, syngas from the first type reactor 102 outlet, combined with additional fuels if needed, is combusted with air to generate heat. Air provided to heat source 106 may be air from the environment surrounding heat source 106. Typically, air provided to heat source 106 comprises nitrogen, oxygen, and argon.

Heat source 106 supplements the heat loss of the metal oxide particles so that the temperature of the metal oxide particles after the second type reactor 104 can be heated up to the same temperature as the metal oxide particles at the first type reactor 102 inlet.

Heat exchange unit 108 increases the temperature of metal oxide particles from the second type reactor 104 using heat from heat source 106. A temperature of the metal oxide particles increases in heat exchange unit 108 such that the temperature of the metal oxide particles exiting heat exchange unit 108 is the same initial temperature as that of the particles at the first type reactor 102 inlet. To be sure, the particles are not transported to heat source 106.

Heat exchange unit 108 provides metal oxide particles to separator 110. Carrier gas may be provided to an outlet stream from heat exchange unit 108 to carry the metal oxide particles to separator 110. In some implementations, a riser may fluidly connect heat exchange unit 108 and separator 110.

Separator 110 separates metal oxide particles from carrier gas. The metal oxide particles are provided to an inlet of the first type reactor 102. Separated carrier gas may be recycled and used again to convey the metal oxide particles.

Without being bound by a particular theory, and when the metal oxide particles comprise Fe₃O₄, the following reactions may occur in exemplary system 100:

$$First type reactor 102 : {CH}_{4} or other fuels + {Fe}_{3} {O}_{4} \to {FeO}_{x} + CO + {H}_{2} + {CO}_{2} + {H}_{2} O \\ 0 < x < 1.33 \\ Second type reactor 104 : ( \frac{3}{4 - 3 x} ) {FeO}_{x} + {H}_{2} O \to ( \frac{1}{4 - 3 x} ) {Fe}_{3} {O}_{4} + {H}_{2} \\ 0 < x < 1.33 \\ \begin{matrix}Heat source 106 : & 2 CO + {O}_{2} \to 2 {CO}_{2} \\ & 2 {H}_{2} + {O}_{2} \to 2 {H}_{2} O \\ & {CH}_{4} + 2 {O}_{2} \to {CO}_{2} + 2 {H}_{2} O\end{matrix}$$

or complete combustion reaction of other fuels.

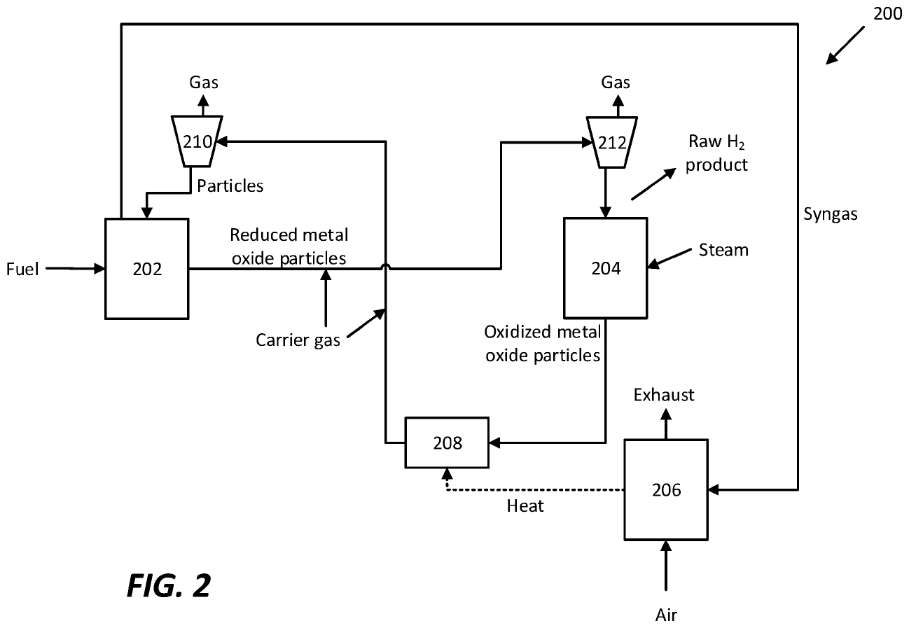

FIG. 2 schematically depicts example system 200 for generating hydrogen (H₂). As shown, system 200 comprises a first type reactor 202, a second type reactor 204, heat source 206, heat exchange unit 208, separator 210, and separator 212. Similarly numbered components shown in FIG. 2 as in FIG. 1 have the same or similar operation as described above with reference to example system 100. Other embodiments may comprise more or fewer components.

In the configuration shown for system 200, the first type reactor 202 is placed beside (or roughly a same distance from a ground level as) the second type reactor 204. Put another way, the second type reactor 204 is horizontally aligned with the first type reactor 202 relative to a ground level. Carrier gas is used to convey metal oxide particles from the outlet of the first type reactor 202 to the separator 212 above the top of the second type reactor 204. Carrier gas is used to convey metal oxide particles from the outlet of the second type reactor 204 to the separator 210 above the top of the first type reactor 202.

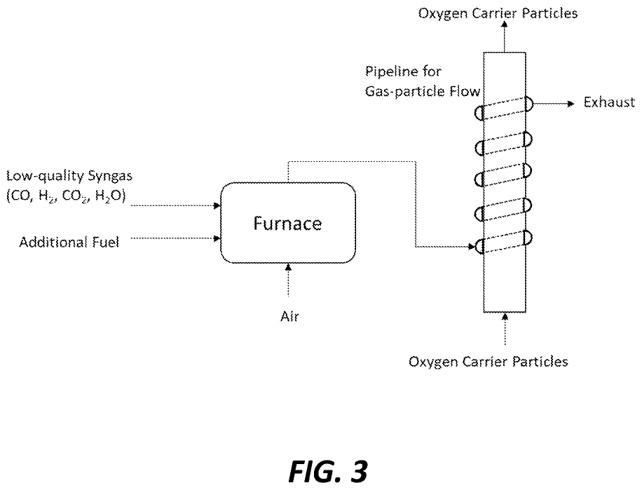

FIG. 3 shows one possible design of the furnace and particles heat integration. The pipelines transporting the hot exhaust gases out of the furnace surround the pipelines transporting solid metal oxide particles out of the second type reactor(s) to transfer the combustion heat from the furnace to the metal oxide particles.

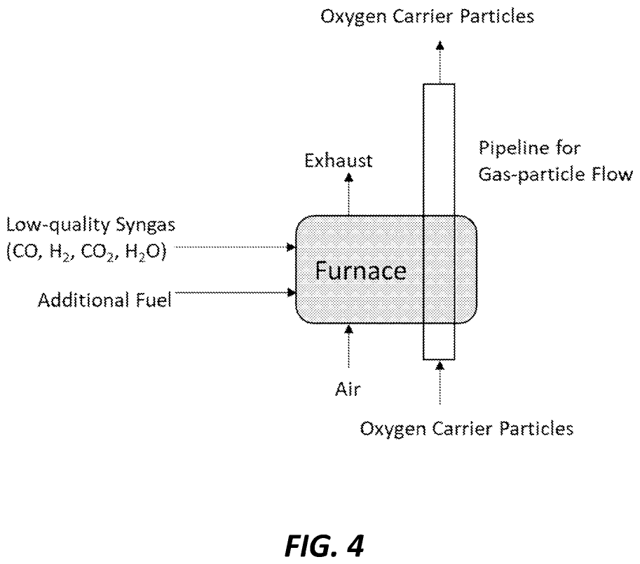

FIG. 4 shows another possible design of the furnace and particles heat integration. The pipelines transporting solid metal oxide particles out of the second type reactor(s) enter through the furnace. With this design, the combustion in the furnace can directly heat the metal oxide particles.

In exemplary processes, one or more heating facilities may be used as an alternative to the heat source, shown as a furnace. For instance, alternative heating facilities may include solar heating systems, electric heating systems, and electromagnetic heating systems. With the external heating facility, the hydrogen yield of exemplary processes can achieve a maximum hydrogen yield (4 mol H₂ per mol CH₄) within the thermodynamic limit. Unlike three-type reactor systems (CL-3R), exemplary two-type reactor systems can theoretically achieve the highest thermodynamic limit of hydrogen conversion with an additional heat source because, in two-type reactor systems, all the reducing ability of the oxygen carrier can be utilized to reduce steam and produce hydrogen.

### III. Exemplary Methods of Operation

Exemplary methods of generating hydrogen may comprise various operations. Exemplary systems described above may be used to implement one or more methods described below. Other embodiments may comprise more or fewer operations than those discussed below.

An example method may comprise providing fuel to one or more first type reactors. Exemplary fuels and various aspects of exemplary first type reactors are discussed in greater detail above. Fuel is provided to the one or more first type reactors at a rate that is below the minimum fluidizing velocity of the solid metal oxide particles. In some instances, the fuel may be pre-heated before entering the one or more first type reactors.

Example methods include providing metal oxide particles to the one or more first type reactors. The metal oxide particles provided to the one or more first type reactors are in an oxidized state.

During operation, the metal oxide particles react with the fuel to generate oxidation products. In some instances, exemplary oxidation products may comprise CO₂, H₂O, CO, H₂, and/or other species. An example method may also comprise providing oxidation products from the one or more first type reactors to a heat source.

The reaction(s) in the one or more first type reactors are endothermic. Thus, the temperature of the metal oxide particles decreases as the particles progress through the one or more first type reactors.

Example methods may include operating the one or more first type reactors at a pressure of about 0.1 MPa to about 30 MPa. In some implementations, the one or more first type reactors may be operated at a pressure between 0.1 MPa to 20 MPa; 0.1 MPa to 15 MPa; 0.5 MPa to 10 MPa; 0.1 MPa to 2 MPa; 1 MPa to 5 MPa; 5 MPa to 25 MPa; or 10 MPa to 30 MPa. In various implementations, the one or more first type reactors may be operated at a pressure of no less than 0.1 MPa; no less than 0.5 MPa; no less than 1 MPa; no less than 2 MPa; no less than 3 MPa; no less than 4 MPa; no less than 5 MPa; no less than 10 MPa; no less than 15 MPa; no less than 20 MPa; no less than 25 MPa; or no less than 30 MPa. In various implementations, the one or more first type reactors may be operated at a pressure of no greater than 30 MPa; no greater than 25 MPa; no greater than 20 MPa; no greater than 17.5 MPa; no greater than 12.5 MPa; no greater than 7.5 MPa; no greater than 5 MPa; no greater than 2.5 MPa; no greater than 1.5 MPa; no greater than 0.8 MPa; no greater than 0.5 MPa or no greater than 0.1 MPa.

Example methods may include operating the one or more first type reactors at a temperature between about 600° C. and about 1300° C. In various instances, the one or more first type reactors may be operated at a temperature no less than 600° C.; no less than 700° C.; no less than 800° C.; no less than 900° C.; no less than 1000° C.; no less than 1100° C.; no less than 1200° C.; or no less than 1300° C. In various instances, the one or more first type reactors may be operated at a temperature no greater than 1300° C.; no greater than 1200° C.; no greater than 1100° C.; or no greater than 1000° C.; no greater than 900° C.; no greater than 800° C.; no greater than 700° C.; or no greater than 600° C. In various instances, the one or more first type reactors may be operated at a temperature between 600-1300° C.; between 600-950° C.; between 950-1300° C.; between 600-1100° C.; between 700-1000° C.; between 600-800° C.; between 800-1000° C.; between 900-1100° C.; or between 1100-1300° C.

Example methods may include providing reduced metal oxide particles from the one or more first type reactors to one or more second type reactors. In some implementations, example methods include providing reduced metal oxide particles to a separation unit, aided by carrier gas. Then, the separation unit separates the reduced metal oxide particles from the carrier gas and provides the reduced metal oxide particles to the one or more second type reactors.

Example methods comprise providing steam (H₂O) to the one or more second type reactors. Steam (H₂O) and reduced metal oxide particles react in the one or more second type reactors to generate hydrogen (H₂) and oxidized metal oxide particles.

Example methods may include operating the one or more second type reactors at a pressure of about 0.1 MPa to about 30 MPa. In some implementations, the one or more second type reactors may be operated at a pressure between 0.1 MPa to 20 MPa; 0.1 MPa to 15 MPa; 0.5 MPa to 10 MPa; 0.1 MPa to 2 MPa; 1 MPa to 5 MPa; 5 MPa to 25 MPa; or 10 MPa to 30 MPa. In various implementations, the one or more second type reactors may be operated at a pressure of no less than 0.1 MPa; no less than 0.5 MPa; no less than 1 MPa; no less than 2 MPa; no less than 3 MPa; no less than 4 MPa; no less than 5 MPa; no less than 10 MPa; no less than 15 MPa; no less than 20 MPa; no less than 25 MPa; or no less than 30 MPa. In various implementations, the one or more second type reactors may be operated at a pressure of no greater than 30 MPa; no greater than 25 MPa; no greater than 20 MPa; no greater than 17.5 MPa; no greater than 12.5 MPa; no greater than 7.5 MPa; no greater than 5 MPa; no greater than 2.5 MPa; no greater than 1.5 MPa; no greater than 0.8 MPa; no greater than 0.5 MPa or no greater than 0.1 MPa.

Example methods may include operating the one or more second type reactors at a temperature between about 600° C. and about 1300° C. In various instances, the one or more second type reactors may be operated at a temperature no less than 600° C.; no less than 700° C.; no less than 800° C.; no less than 900° C.; no less than 1000° C.; no less than 1100° C.; no less than 1200° C.; or no less than 1300° C. In various instances, the one or more second type reactors may be operated at a temperature no greater than 1300° C.; no greater than 1200° C.; no greater than 1100° C.; or no greater than 1000° C.; no greater than 900° C.; no greater than 800° C.; no greater than 700° C.; or no greater than 600° C. In various instances, the one or more second type reactors may be operated at a temperature between 600-1300° C.; between 600-950° C.; between 950-1300° C.; between 600-1100° C.; between 700-1000° C.; between 600-800° C.; between 800-1000° C.; between 900-1100° C.; or between 1100-1300° C.

Steam provided to the one or more second type reactors may have a pressure between 0.1 MPa and 30 MPa. Steam provided to the one or more second type reactors may have a temperature between 100° C. and 1000° C. In some implementations, steam may be provided to the one or more second type reactors at a temperature between 200° C. and 800° C.; between 200° C. and 600° C.; between 300° C. and 500° C.; or between 350° C. and 450° C.

In some implementations, fuel provided to the one or more first type reactors comprises methane (CH₄), which may be present in biogas. In some instances, a molar ratio of steam (H₂O) to methane (CH₄) provided to the reactor system may be between 3.85:1 and 3.95:1; between 3.87:1 and 3.93:1; between 3.85:1 and 3.9:1. In some instances, a molar ratio of steam (H₂O) to methane (CH₄) provided to the reactor system may be 3.9:1.

Raw hydrogen (H₂) product is provided from the one or more second type reactors. Oxidized metal oxide particles are provided from the one or more second type reactors to a heat exchange unit. In some instances, exemplary methods may comprise providing a carrier gas to convey the oxidized metal oxide particles to the heat exchange unit and/or a separation unit.

Example methods may include operating a heat source to generate heat via combustion. In some instances, product gases from the one or more first type reactors may be mixed with air, and in some instances biogas.

In various implementations, an operational temperature of the heat source may be between 900° C. and 1300° C.; between 900° C. and 1100° C.; between 1100° C. and 1300° C.; between 900° C. and 1050° C.; between 1000° C. and 1100° C.; between 1000° C. and 1100° C.; between 1100° C. and 1200° C.; or between 1200° C. and 1300° C. In various implementations, an operational temperature of the heat source may be no less than 900° C.; no less than 1000° C.; no less than 1100° C.; no less than 1200° C.; or no less than 1300° C. In various implementations, an operational temperature of the heat source may be no greater than 1300° C.; no greater than 1200° C.; no greater than 1100° C.; no greater than 1000° C.; or no greater than 900° C.

In the heat exchange unit, heat generated by the heat source is used to increase the temperature of the oxidized metal oxide particles. After the heat exchange unit, the oxidized metal oxide particles are provided to a separation unit at a temperature between 900° C. and 1100° C.; between 900° C. and 1050° C.; between 1000° C. and 1100° C.; or between 1000° C. and 1050° C.

An exemplary method may include separating oxidized metal oxide particles from carrier gas. Separated carrier gas may be recycled and used to convey metal oxide particles. The separated metal oxide particles are provided to the one or more first type reactors.

### IV. Experimental Data

Various data were computationally generated, and the results are described below.

Four processes for H₂ production employing biogas as the feedstock, including the CLWS-2R, CLWS-3R, SR-BTH, and MR-BTH, were simulated in ASPEN Plus V.11 software.

The simulation specified the biogas compositions as 68% CH₄, 25% CO₂, and 7% N₂. Solid species used for the CL-2R system simulation comprised Magnetite (Fe₃O₄) and Silicon Carbide (SIC). During reactions in the CL-2R system, Wüstite (Fe_{0.947}O) and Iron (Fe) were generated. Solid species used for the CL-3R system simulation comprised Hematite (Fe₂O₃) and Silicon Carbide (SiC). During reactions in the CL-3R system, Magnetite (Fe₃O₄), Wüstite (Fe_{0.947}O) and Iron (Fe) were generated.

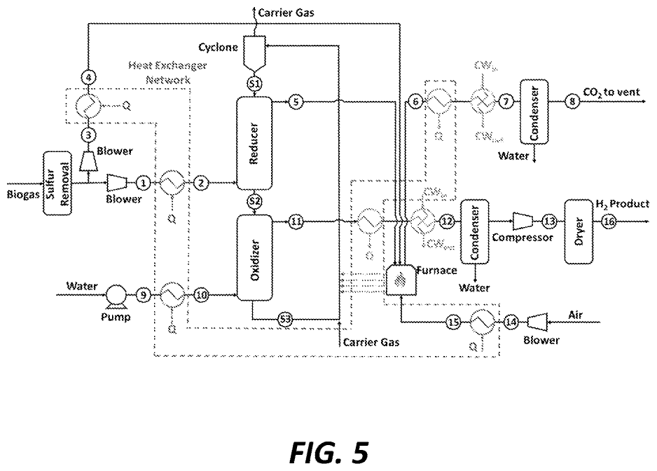

FIG. 5 shows the flow diagram of the CL-2R system. Table 1, below, shows various performance data from the simulations.

TABLE 1
System performance comparison of the four hydrogen
production methods with biogas as the feedstock

| Process | Unit | CL-2R | CL-3R | MR | SR |
|---|---|---|---|---|---|
| Biogas input | kmol/hr | 7297 | 7329 | 7471 | 8150 |
| CO₂ volume fraction | 1 | 0.25 | 0.25 | 0.25 | 0.25 |
| Cold gas efficiency | 1 | 0.75 | 0.75 | 0.73 | 0.67 |
| Effective thermal | 1 | 0.71 | 0.69 | 0.68 | 0.60 |
| efficiency | | | | | |
| H₂ production | ton/hr | 25 | 25 | 25 | 25 |
| Auxiliary power required | MW | 47 | 60 | 56 | 89 |

Based on the simulation results in Table 1, it can be implied that the proposed CL-2R has the highest cold gas efficiency and effective thermal efficiency, as well as the smallest required auxiliary power among the four processes.

In addition, compared with MR and SR processes, CL-2R and CL-3R eliminate the need for the downstream water-gas shift reactor and PSA unit, resulting in substantial capital cost savings for hydrogen production. Compared with CL-3R, CL-2R replaces the conventional chemical looping combustor with a simple furnace to further save the capital cost. Moreover, CL-2R can also reduce particle attrition after removing the fluidized bed combustor in CL-3R. The experimental data show the CL-2R in FIG. 5 is economically advantageous over the conventional processes and CL-3R for hydrogen production.

### Exemplary Embodiments

For reasons of completeness, various aspects of the technology are set out in the following numbered embodiments:

Embodiment 1. A method of operating a reactor system, the method comprising: providing metal oxide particles to a first type reactor, the metal oxide particles comprising metal oxide selected from ZnO, SnO₂, Fe₃O₄, NiO, MnO₂, CoO, and Cr₂O₃ and an inert material; providing gaseous fuel to the first type reactor, thereby reacting the metal oxide particles with the gaseous fuel to generate oxidation products and reduced metal oxide particles; operating the first type reactor at a temperature between 800° C. and 1100° C.; providing oxidation products from the first type reactor to a heat source unit; providing reduced metal oxide particles from the first type reactor to a second type reactor; providing steam to the second type reactor, thereby reacting the reduced metal oxide particles with the steam to generate hydrogen (H₂) and oxidized metal oxide particles; collecting hydrogen (H₂) from the second type reactor; operating the second type reactor at a temperature between 800° C. and 1100° C.; providing oxidized metal oxide particles to a heat exchange unit; providing heat from the heat source unit to the heat exchange unit; increasing the temperature of the oxidized metal oxide particles in the heat exchange unit; providing oxidized metal oxide particles from the heat exchange unit to a separation unit; separating oxidized metal oxide particles from carrier gas in the separation unit; and providing oxidized metal oxide particles from the separation unit to the first type reactor.

Embodiment 2. The method according to embodiment 1, the gaseous fuel comprising 50-80 vol % methane (CH₄), 25-50 vol % carbon dioxide (CO₂) and 0-10 vol % nitrogen (N₂).

Embodiment 3. The method according to embodiment 2, wherein a molar ratio of steam (H₂O) to methane (CH₄) provided to the reactor system is between 3.85:1 and 3.95:1.

Embodiment 4. The method according to any one of embodiments 1-3, the inert material comprising SiO₂, SiC, Al₂O₃, MgO, CaO, TiO₂, MgAl₂O₄, ZrO₂, yttria-stabilized ZrO₂, alumina-silicates, clay supports such as kaolin and bentonite, alumina-zirconia-silica, and combinations thereof.

Embodiment 5. The method according to any one of embodiments 1-4, wherein the metal oxide particles comprise Fe₃O₄ and SiC.

Embodiment 6. The method according to any one of embodiments 1-5, wherein the metal oxide particles comprise 20-40 wt % Fe₃O₄ and 60-80 wt % SiC.

Embodiment 7. The method according to any one of embodiments 1-6, wherein the metal oxide particles are provided at a top portion of the first type reactor; and wherein the gaseous fuel is provided at a bottom portion of the first type reactor.

Embodiment 8. The method according to any one of embodiments 1-7, wherein the reduced metal oxide particles are provided at a top portion of the second type reactor; and wherein the steam is provided at a bottom portion of the second type reactor.

Embodiment 9. The method according to any one of embodiments 1-8, wherein the oxidized metal oxide particles provided from the heat exchange unit have a temperature between 900° C. and 1100° C.

Embodiment 10. The method according to any one of embodiments 1-9, wherein steam provided to the second type reactor has a temperature between 200° C. and 800° C.

Embodiment 11. The method according to any one of embodiments 1-10, further comprising providing air to the heat source unit; and generating heat in the heat source unit by reacting oxidation products from the first type reactor with the air.

Embodiment 12. The method according to any one of embodiments 1-11, further comprising operating the heat source unit at a temperature between 900° C. and 1300° C.

Embodiment 13. The method according to any one of embodiments 1-12, further comprising: providing reduced metal oxide particles from the first type reactor to the second type reactor, where the second type reactor is horizontally aligned with the first type reactor relative to a ground level.

Embodiment 14. The method according to any one of embodiments 1-13, wherein the heat exchange unit and the heat source unit are the same unit.

Embodiment 15. A reactor system, comprising: at least one first type reactor in fluid communication with a fuel source and a separation unit, the at least one first type reactor configured to: receive metal oxide particles from the separation unit; generate oxidation products by reacting the metal oxide particles with fuel from the fuel source; and provide the oxidation products from an outlet; at least one second type reactor in fluid communication with the at least one first type reactor, the at least one second type reactor configured to receive steam from a steam source; receive reduced metal oxide particles from the at least one first type reactor; generate hydrogen (H₂) by reacting the steam and the reduced metal oxide particles; and provide hydrogen (H₂) from an outlet of the at least one second type reactor; a heat source unit in fluid communication with an outlet of the at least one first type reactor and configured to receive oxidation products from the at least one first type reactor; a heat exchange unit in fluid communication with the at least one second type reactor and configured to: receive heat from the heat source unit; receive oxidized metal oxide particles from the at least one second type reactor; provide oxidized metal oxide particles at an increased temperature to the separation unit, the increased temperature being relative to a temperature exiting the at least one second type reactor; and the separation unit being in fluid communication with the heat exchange unit and the at least one first type reactor, the separation unit configured to separate a carrier gas from the oxidized metal oxide particles and provide the oxidized metal oxide particles to the at least one first type reactor.

Embodiment 16. The reactor system according to embodiment 15, wherein the metal oxide particles comprise metal oxide selected from ZnO, SnO₂, Fe₃O₄, NiO, MnO₂, CoO, and Cr₂O₃ and an inert material comprising SiO₂, SiC, Al₂O₃, MgO, CaO, TiO₂, MgAl₂O₄, ZrO₂, yttria-stabilized ZrO₂, alumina-silicates, clay supports such as kaolin and bentonite, alumina-zirconia-silica, and combinations thereof; and wherein the fuel comprises biogas.

Embodiment 17. The reactor system according to embodiment 15 or embodiment 16, wherein the heat exchange unit comprises one or more pipelines surrounding pipelines transporting oxidized metal oxide particles from the at least one second type reactor.

Embodiment 18. The reactor system according to any one of embodiments 15-17, wherein the heat exchange unit comprises one or more pipelines transporting oxidized metal oxide particles passing through the heat source unit.

Embodiment 19. The reactor system according to any one of embodiments 15-18, wherein the at least one first type reactor is positioned vertically above the at least one second type reactor.

Embodiment 20. The reactor system according to any one of embodiments 15-19, wherein the at least one first type reactor is positioned vertically even with the at least one second type reactor.

It is understood that the foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, pH and temperature adjustments, separation, recovery, or methods of use, may be made without departing from the spirit and scope of the disclosure.

1. A method of operating a reactor system, the method comprising:
providing metal oxide particles to a first type reactor, the metal oxide particles comprising metal oxide selected from ZnO, SnO₂, Fe₃O₄, NiO, MnO₂, CoO, and Cr₂O₃ and an inert material;
providing gaseous fuel to the first type reactor, thereby reacting the metal oxide particles with the gaseous fuel to generate oxidation products and reduced metal oxide particles;
operating the first type reactor at a temperature between 800° C. and 1100° C.;
providing oxidation products from the first type reactor to a heat source unit;
providing reduced metal oxide particles from the first type reactor to a second type reactor;
providing steam to the second type reactor, thereby reacting the reduced metal oxide particles with the steam to generate hydrogen (H₂) and oxidized metal oxide particles;
collecting hydrogen (H₂) from the second type reactor;
operating the second type reactor at a temperature between 800° C. and 1100° C.;
providing oxidized metal oxide particles to a heat exchange unit;
providing heat from the heat source unit to the heat exchange unit;
increasing the temperature of the oxidized metal oxide particles in the heat exchange unit;
providing oxidized metal oxide particles from the heat exchange unit to a separation unit;
separating oxidized metal oxide particles from carrier gas in the separation unit; and
providing oxidized metal oxide particles from the separation unit to the first type reactor.

2. The method according to claim 1, the gaseous fuel comprising 50-80 vol % methane (CH₄), 25-50 vol % carbon dioxide (CO₂) and 0-10 vol % nitrogen (N₂).

3. The method according to claim 2, wherein a molar ratio of steam (H₂O) to methane (CH₄) provided to the reactor system is between 3.85:1 and 3.95:1.

4. The method according to claim 1, the inert material comprising SiO₂, SiC, Al₂O₃, MgO, CaO, TiO₂, MgAl₂O₄, ZrO₂, yttria-stabilized ZrO₂, alumina-silicates, clay supports such as kaolin and bentonite, alumina-zirconia-silica, and combinations thereof.

5. The method according to claim 1, wherein the metal oxide particles comprise Fe₃O₄ and SiC.

6. The method according to claim 5, wherein the metal oxide particles comprise 20-40 wt % Fe₃O₄ and 60-80 wt % SiC.

7. The method according to claim 1, wherein the metal oxide particles are provided at a top portion of the first type reactor; and
wherein the gaseous fuel is provided at a bottom portion of the first type reactor.

8. The method according to claim 7, wherein the reduced metal oxide particles are provided at a top portion of the second type reactor; and
wherein the steam is provided at a bottom portion of the second type reactor.

9. The method according to claim 1, wherein the oxidized metal oxide particles provided from the heat exchange unit have a temperature between 900° C. and 1100° C.

10. The method according to claim 1, wherein steam provided to the second type reactor has a temperature between 200° C. and 800° C.

11. The method according to claim 1, further comprising providing air to the heat source unit; and
generating heat in the heat source unit by reacting oxidation products from the first type reactor with the air.

12. The method according to claim 11, further comprising operating the heat source unit at a temperature between 900° C. and 1300° C.

13. The method according to claim 12, further comprising:
providing reduced metal oxide particles from the first type reactor to the second type reactor, where the second type reactor is horizontally aligned with the first type reactor relative to a ground level.

14. The method according to claim 1, wherein the heat exchange unit and the heat source unit are the same unit.

15. A reactor system, comprising:
at least one first type reactor in fluid communication with a fuel source and a separation unit, the at least one first type reactor configured to:
receive metal oxide particles from the separation unit;
generate oxidation products by reacting the metal oxide particles with fuel from the fuel source; and
provide the oxidation products from an outlet;
at least one second type reactor in fluid communication with the at least one first type reactor, the at least one second type reactor configured to
receive steam from a steam source;
receive reduced metal oxide particles from the at least one first type reactor;
generate hydrogen (H₂) by reacting the steam and the reduced metal oxide particles; and
provide hydrogen (H₂) from an outlet of the at least one second type reactor;
a heat source unit in fluid communication with an outlet of the at least one first type reactor and configured to receive oxidation products from the at least one first type reactor;
a heat exchange unit in fluid communication with the at least one second type reactor and configured to:
receive heat from the heat source unit;
receive oxidized metal oxide particles from the at least one second type reactor;
provide oxidized metal oxide particles at an increased temperature to the separation unit, the increased temperature being relative to a temperature exiting the at least one second type reactor; and
the separation unit being in fluid communication with the heat exchange unit and the at least one first type reactor, the separation unit configured to separate a carrier gas from the oxidized metal oxide particles and provide the oxidized metal oxide particles to the at least one first type reactor.

16. The reactor system according to claim 15, wherein the metal oxide particles comprise metal oxide selected from ZnO, SnO₂, Fe₃O₄, NiO, MnO₂, CoO, and Cr₂O₃ and an inert material comprising SiO₂, SiC, Al₂O₃, MgO, CaO, TiO₂, MgAl₂O₄, ZrO₂, yttria-stabilized ZrO₂, alumina-silicates, clay supports such as kaolin and bentonite, alumina-zirconia-silica, and combinations thereof; and
wherein the fuel comprises biogas.

17. The reactor system according to claim 16, wherein the heat exchange unit comprises one or more pipelines surrounding pipelines transporting oxidized metal oxide particles from the at least one second type reactor.

18. The reactor system according to claim 16, wherein the heat exchange unit comprises one or more pipelines transporting oxidized metal oxide particles passing through the heat source unit.

19. The reactor system according to claim 16, wherein the at least one first type reactor is positioned vertically above the at least one second type reactor.

20. The reactor system according to claim 16, wherein the at least one first type reactor is positioned vertically even with the at least one second type reactor.
